(19) United States
(12) Patent Application Publication
(10) Pub. No.: US 2020/0034156 A1
(43) Pub. Date: Jan. 30, 2020

(54) Resource Optimization and Reuse in Resource Constrained Environment

(71) Applicant: Futurewei Technologies, Inc., Plano, TX (US)

(72) Inventors: Ravi Shanker Chuppala, Cupertino, CA (US); Jun Xu, Cupertino, CA (US)

(21) Appl. No.: 16/045,457

(22) Filed: Jul. 25, 2018

(51) Int. Cl. G06F 9/445; G06F 9/50

(52) U.S. Cl. CPC G06F 9/44505; G06F 9/5061

(57) ABSTRACT

A computer implemented method for executing applications on a host system. The method includes identifying application execution code of an application and a set of application execution dependencies of the application. The method creates a basic run-time environment (BRE) for the application on the host system. The method maps a root file system of the host system into the BRE. The method copies the application execution code of the application to an application directory in the BRE. The method maps the resource files of the host system to the directories in the BRE for the set of application execution dependencies corresponding to the resource files. The method initiates execution of the application through the BRE using the resource files of the host system that are mapped to the set of application execution dependencies of the application in the BRE.

### CROSS-REFERENCE TO RELATED APPLICATIONS

Not applicable.

### TECHNICAL FIELD

Embodiments of the present disclosure relate to the field of resource optimization, and in particular, to a method and an apparatus for sharing resources of a host system.

### BACKGROUND

An embedded system is a combination of computer hardware and software that is designed to perform a dedicated or a particular set of functions. Embedded systems like Internet of Things (IoT) Gateways are resource constrained/restrictive environments. To accommodate third party applications, the embedded system environment requires an open architecture where other third party applications can coexist with existing system applications. The third party application requires system resources and execution permission to operate in a conducive environment.

### SUMMARY

The present disclosure describes various embodiments in a computer implemented method, apparatus, and computer program product for executing applications on a host system. As an example, in one embodiment, a method for executing applications on a host system includes identifying application execution code of an application and a set of application execution dependencies of the application. The method identifies resource files of the host system. The method determines that the resource files of the host system include resource files that correspond to the set of application execution dependencies of the application. The method creates a basic run-time environment (BRE) for the application on the host system. The method maps a root file system of the host system into the BRE. The method creates directories in the BRE for the set of application execution dependencies. The method copies the application execution code of the application to an application directory in the BRE. The method maps the resource files of the host system to the directories in the BRE for the set of application execution dependencies corresponding to the resource files. The method initiates execution of the application through the BRE using the resource files of the host system that are mapped to the set of application execution dependencies of the application in the BRE.

Additional details of the above embodiment and other embodiments, as well as the advantages thereof, are further described in the Detailed Description.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram illustrating a system architecture depicting a single application sharing resources of a host system in accordance with an embodiment of the present disclosure.

FIG. 2 is a schematic diagram illustrating the system architecture depicting two applications sharing resources of a host system in accordance with an embodiment of the present disclosure.

FIG. 3 is a flowchart illustrating a method for sharing resources of a host system in accordance with an embodiment of the present disclosure.

FIG. 4 is a schematic diagram illustrating an apparatus in accordance with an embodiment of the present disclosure.

The illustrated figures are only exemplary and are not intended to assert or imply any limitation with regard to the environment, architecture, design, or process in which different embodiments may be implemented. Any optional component or steps are indicated using dash lines in the illustrated figures.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

As used within the written disclosure and in the claims, the terms “including” and “comprising” are used in an open-ended fashion, and thus should be interpreted to mean “including, but not limited to”. Unless otherwise indicated, as used throughout this document, “or” does not require mutual exclusivity, and the singular forms “a”, “an”, and “the” are intended to include the plural forms as well, unless the context clearly indicates otherwise.

A module or unit as referenced herein may comprise one or more hardware or electrical components such as electrical circuitry, processors, and memory that may be specially configured to perform a particular function. The memory may be volatile memory or non-volatile memory that stores data such as, but not limited to, computer executable instructions, machine code, and other various forms of data. The module or unit may be configured to use the data to execute one or more instructions to perform one or more tasks. In certain instances, a unit may also refer to a particular set of functions, software instructions, or circuitry that is configured to perform a specific task.

A network as referenced herein means a system of electronic devices that are joined together via communication links to enable the exchanging of information and/or the sharing of resources. Non-limiting examples of networks include local-area networks (LANs), wide-area networks (WANs), metropolitan-area networks (MANs), passive optical networks (PONs), and radio access networks (RANs). The networks may include one or more private networks and/or public networks such as the Internet. In various embodiments, the networks may employ any type of communication standards and/or protocol.

As stated above, embedded systems like Internet of Things (IoT) Gateways are resource constrained/restrictive environment. To accommodate third party applications, the embedded system environment requires an open architecture where other third party applications can coexist with existing system application. The third party application requires system resources and execution permission to operate in a conducive environment.

A current trend by application developers is to package third party applications in a container environment. A container is a software package that contains an application and all its dependencies (e.g., libraries/binary files, frameworks, etc.) together in one package. Containers make it easier for developers to know that their software will run, no matter where it is deployed, because everything that is needed to run the software is packaged in the container. However, this convenience introduces a great deal of layering and duplication of libraries and binary files that may constrain the system resources of a host system such as an embedded system. For example, if multiple containers include applications that have the same dependencies, each container maintains its own copy of libraries and binary files. This duplication of libraries and binary files may constrain the resources of the host system.

Accordingly, the disclosed embodiments seek to enable resource constrained systems to support third party applications such as, but not limited to, applications in container environments, that may not otherwise have been able to run on a resource constrained system. For example, the present disclosure provides various embodiments for optimizing the resource constrained system by eliminating the layering/duplication and sharing/reusing of the file systems on the host (e.g., host root file system and applications libraries/binaries (libs/bins)) by maintaining a single copy of the libs/bins on the host system. With a single copy of dependent libraries/binaries tools, the execution dependencies of one or more applications may be mapped to the libraries/binary files of the host system for executing the applications. Applications no longer need to maintain any copies of the application dependent libraries, thus conserving the resources of the host system. Advantages of the disclosed embodiments include, but are not limited to, eliminating layering for application containers, eliminating the duplication of bins/libs, and enhancing the resource optimization in resource constrained environment.

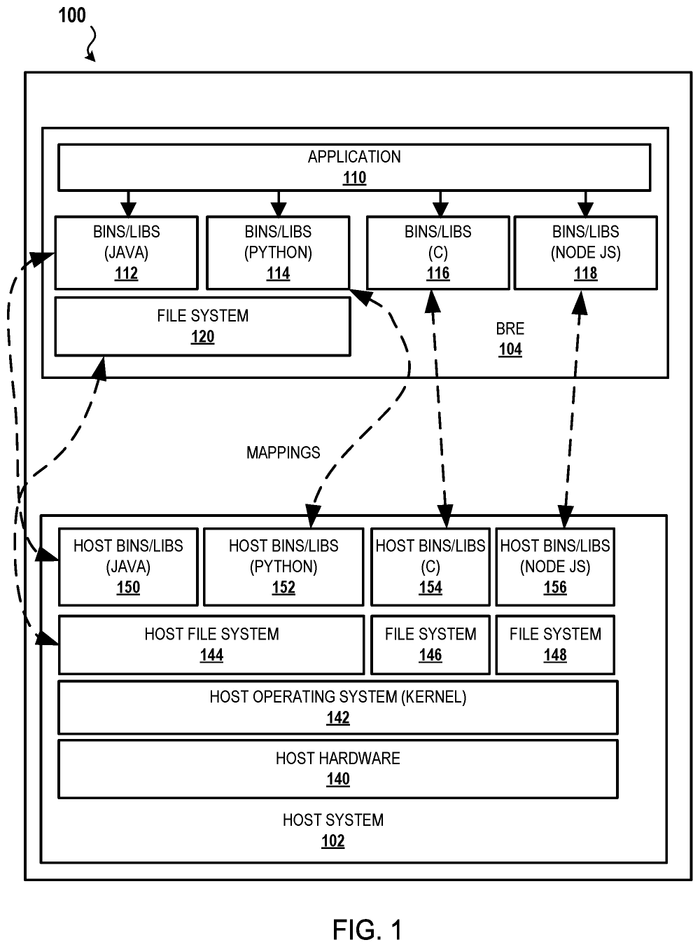

FIG. 1 is a schematic diagram illustrating a system architecture 100 depicting a single application sharing resources of a host system 102 in accordance with an embodiment of the present disclosure. In the depicted embodiment, the host system 102 includes host hardware 140. The host hardware 140 represents the actual hardware resources of the system such as, but not limited to, one or more processor/microcontroller/central processing units (CPUs), sensors, protection circuitry, memory, persistent storage, and I/O devices. The CPU is responsible for running or executing programs or other instructions. The processing speed, memory space, and other specifications may vary in different embodiments based on the operating system or other application requirements.

The host operating system 142 is installed on the host system 102. The host operating system 142 comprises the software that supports the host's basic functions, such as scheduling tasks, executing applications, managing hardware devices such as the hard disk, and controlling peripherals. The host operating system 142 includes a kernel that is the core of the operating system. The kernel may load as part of the system start-up process and may handle the rest of start-up as well as input/output requests from software and peripherals, translating them into data-processing instructions for the CPU.

The host operating system 142 includes a host file system 144. The host file system 144 is the methods and data structures that the host operating system 142 uses to maintain or organize every piece of data on a storage device or partition. The host file system 144 may be any type of file system. Non-limiting examples of file systems include File Allocation Table (FAT) file system, New Technology File System (NTFS), Hierarchical File System (HFS), Unix File System (UFS), Extended File System (EXT), and Journaled File System (JFS). In certain embodiments, the host operating system 142 may support multiple file systems such as file system 146 and file system 148 in one or more partitions. File system 146 and file system 148 may be any type of file system.

Additionally, in accordance with the present embodiments, the host system 102 may include one or more binary files and libraries written in various programming languages such as, but not limited to, host bins/libs (Java) 150, host bins/libs (python) 152, host bins/libs (C) 154, and host bins/libs (node JS) 156. Java, python, C, and node (JavaScript) JS are different programming languages. For instance, JavaScript is a programming language often used for the Web. Binary files include image files, sound files, executable (i.e., runnable) programs and compressed data files. Libraries contain code and data that provide services to applications. For example, a library may include a collection of subroutines or classes for performing a particular function.

In the depicted embodiment, an application 110 is executed on the host system 102. In certain embodiments, the application 110 may have been extracted from a container environment. A container packages the application 110, libraries/binary files, frameworks, and its dependencies together. As described above, although containers make it easier for developers to know that their software will run, no matter where it is deployed, the container environment introduces a great deal of layering and duplication of libraries and binary files that may constrain the system resources of the host system 102.

Thus, in accordance with an embodiment, the application 110 is extracted from the container and executed in a basic run-time environment (BRE) 104. The BRE 104 enables the application 110 to have access to resources on the host system 102 such as software libraries, system variables and environment variables, and provide all necessary services and support to the processes involved in the execution of the application 110. Instead of using the libraries and binary files in the container environment for execution of the application 110, the application 110 dependencies are mapped to the resources of the host system 102 as shown in FIG. 1. For example, the file system 120 of the application 110 may be mapped to a file system of the host system 102 such as host file system 144. Each of the binary/library files of the application 110 (bins/libs (Java) 112, bins/libs (python) 114, bins/libs (c) 116, bins/libs (node JS) 118) are mapped to corresponding binary/library files (host bins/libs (Java) 150, host bins/libs (python) 152, host bins/libs (C) 154, and host bins/libs (node JS) 156) of the host system 102. The mapping enables the application 110 to use the system resources of the host system 102 instead of having to have its own copies of the application dependencies. Thus, by mapping the resources of the host system 102 to the dependencies of the application 110, duplication of resources binary and library files may be avoided, and therefore conserving system resources of the host system 102.

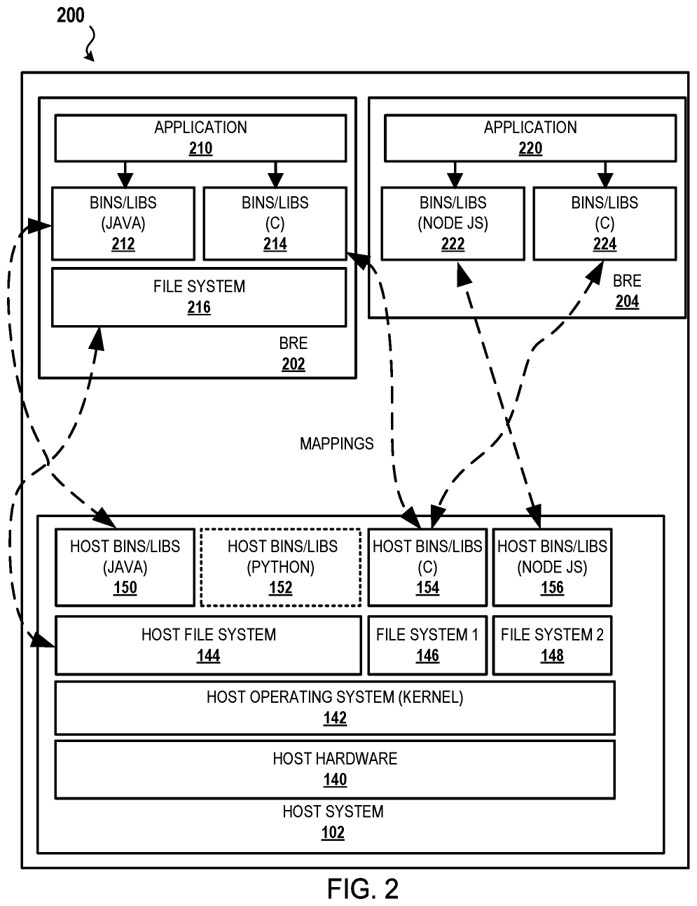

The disclosed embodiments achieve even greater conservation of system resources as more applications are executed on the host system 102. For example, FIG. 2 is a schematic diagram illustrating the system architecture 200 depicting two applications sharing resources of the host system 102 in accordance with an embodiment of the present disclosure. In the depicted embodiment, an application 210 is executed in a BRE 202. The respective dependencies of the application 210 (bins/libs (Java) 212, bins/libs (C) 214, and file system 216) are mapped to the corresponding binary/library files (host bins/libs (Java) 150, host bins/libs (C) 154, and host file system 144) of the host system 102. Additionally, an application 220 is executed in a BRE 204. The respective dependencies of the application 220 (bins/libs (node JS) 222, and bins/libs (C) 224) are mapped to the corresponding binary/library files (host bins/libs (C) 154, and host bins/libs (node JS) 156) of the host system 102. As shown in FIG. 2, both application 210 and application 220 are able to share the host bins/libs (C) 154 of the host system 102 thus conserving system resources.

In addition, in some embodiments, if a host resource is not being used by any application, such as host bins/libs (python) 152 in FIG. 2, the host system 102 may remove the unused resource to conserve space. The host bins/libs (python) 152 may have been previously installed on the host to service another application. In some embodiments, the host system 102 may keep the unused resource until space is needed by the host system 102 in case a new application requires the resource.

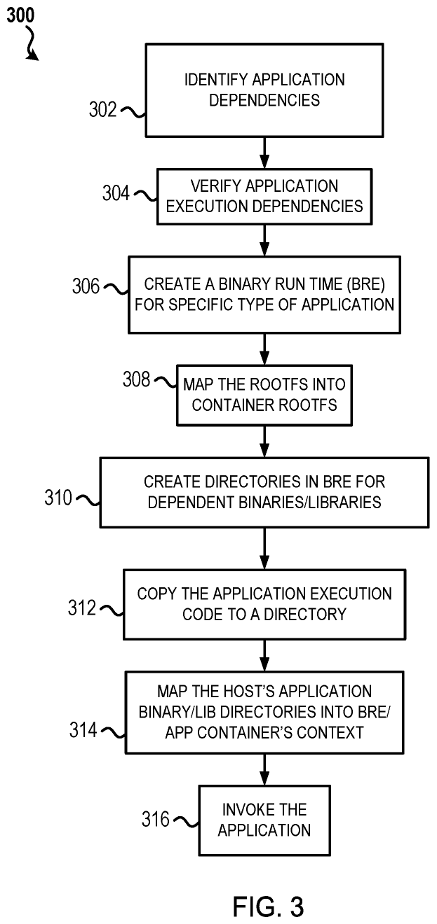

FIG. 3 is a flowchart illustrating a method 300 for sharing resources of a host system in accordance with an embodiment of the present disclosure. In one embodiment, the method 300 may be performed by a host system such as host system 102 in FIGS. 1 and 2.

In the depicted embodiment, the method 300, at step 302, begins by identifying the application execution code of an application and a set of application execution dependencies of the application. The set of application execution dependencies may include file system type, binary files, and libraries that the application relies on for execution. In one embodiment, the set of application execution dependencies may be identified by analyzing the directories and files of a container containing the application. In some embodiments, the set of application execution dependencies may be identified by analyzing the application execution code of the application.

At step 304, the method 300 verifies that the set of application execution dependencies are installed on the host system and are accessible to the application or the run-time environment of the application. In one embodiment, the method 300 identifies the resource files installed on the host system and determines whether the resource files of the resource constrained host system includes resource files that correspond to the set of application execution dependencies of the application. If an application dependency is not installed on the host system, the method 300 retrieves and installs the application dependency. The application dependency may be retrieved from a local data storage device or, if not locally available, the application dependency may be retrieved from a remote device over a network communication for installation. In some embodiments, the application dependency may be extracted from a container of the application.

The method 300, at step 306, creates a basic run-time environment (BRE) for the specific type of application. For example, if the application is a java application, the BRE for the application may be a java run-time environment (JRE). If the application is a nodeJS application, the BRE for the application may be a python interpreter. Each BRE may be different in terms of functionality, system resource, access permission, and execution permission depending on the requirements of the application.

At step 308, the method 300 maps or mounts the rootfile system (rootfs) into BRE rootfs of the application to enable sharing of the host root file system with the BRE to enable to the application to be executed on the host system. At step 310, the method 300 creates corresponding directories in BRE for the application and the set of application execution dependencies.

The method 300, at step 312, copies the application execution code (e.g., from a container) to the application directory in the BRE. At step 314, the method 300 maps or mounts the respective resource files of the host system to the corresponding dependency directories in the BRE. The method 300, at step 316, invokes the application through the BRE using the application dependency mappings such that the application executes using the resource files of the host system that are mapped to the corresponding set of application execution dependencies in the BRE. The method 300 may be repeated for each additional application that is executed on the host system.

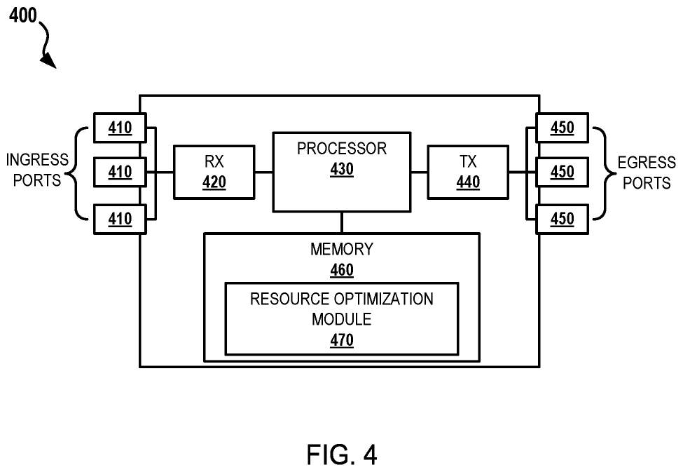

FIG. 4 is a schematic diagram of an apparatus 400 configured to implement one or more of the methods disclosed herein according to an embodiment of the disclosure. It should be noted that the apparatus 400 is intended to illustrate a basic example of a system that may be used to implement one or more of the various embodiments described herein. For example, the apparatus 400 may be used to implement an IoT gateway or other embedded systems that are configured to perform the methods described herein. The depicted apparatus 400 is not intended to be limiting with respect to any of the claims in the present application because the described components may be combined, modified, or replaced in various systems without departing from the scope of the claims. Additionally, in certain embodiments, the apparatus 400 may include additional components not depicted in FIG. 4 to implement one or more features of the claims.

Referring now to the depicted embodiment, the apparatus 400 comprises ingress ports 410 and receiver units (Rx) 420 for receiving data, a processor 430 to process the data, transmitter units (TX) 440 and egress ports 450 for transmitting the data, and a memory 460 for storing the data. The apparatus 400 may also comprise optical-to-electrical (OE) components and electrical-to-optical (EO) components coupled to the ingress ports 410, the receiver units 420, the transmitter units 440, and the egress ports 450 for converting optical signals to electrical signals, and vice-versa.

The memory 460 comprises one or more disks, tape drives, or solid-state drives and may be used as an over-flow data storage device, to store programs when such programs are selected for execution, or to store instructions and data that are read during program execution. The memory 460 may be volatile and/or non-volatile and may be read-only memory (ROM), random-access memory (RAM), ternary content-addressable memory (TCAM), or static random-access memory (SRAM).

The processor 430 is implemented by any suitable combination of hardware, middleware, firmware, and software. The processor 430 may be implemented as one or more central processing unit (CPU) chips, cores (e.g., as a multi-core processor), field-programmable gate arrays (FPGAs), application specific integrated circuits (ASICs), or digital signal processors (DSPs). The processor 430 is in communication with the ingress ports 410, receiver units 420, transmitter units 440, egress ports 450, and memory 460. In one embodiment, the memory 460 comprises a resource optimization module 470. The resource optimization module 470 comprises executable instructions for implementing the disclosed embodiments as described above. The processor 430 is configured to execute the executable instructions. The executable instructions may be in any form including high level code to machine code consisting of binary or hexadecimal instructions.

Accordingly, the disclosed embodiments enable resource constrained systems to support multiple third party applications such as, but not limited to, applications in container environments, that may not otherwise have been able to run on a resource constrained system by mapping application dependencies to the resource files of the host system.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, units, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A computer implemented method for executing applications on a host system, the method comprising:
identifying application execution code of an application and a set of application execution dependencies of the application;
identifying resource files of the host system;
determining that the resource files of the host system include resource files that correspond to the set of application execution dependencies of the application;
creating a basic run-time environment (BRE) for the application on the host system;
mapping a root file system of the host system into the BRE;
creating directories in the BRE for the set of application execution dependencies;
copying the application execution code of the application to an application directory in the BRE;
mapping the resource files of the host system to the directories in the BRE for the set of application execution dependencies corresponding to the resource files; and
initiating execution of the application through the BRE using the resource files of the host system that are mapped to the set of application execution dependencies of the application in the BRE.

2. The method of claim 1, wherein the application execution code of the application and the set of application execution dependencies of the application are packaged in a container.

3. The method of claim 1, wherein the resource files of the host system includes a plurality of different types of file systems.

4. The method of claim 1, wherein the set of application execution dependencies comprises at least two application dependent libraries each written in different programming languages.

5. The method of claim 4, wherein the programming languages includes Java, Python, C, and Node JS.

6. The method of claim 1, wherein the set of application execution dependencies includes various types of application dependent binary files.

7. The method of claim 1, wherein the basic run-time environment is of a same type as the application.

8. The method of claim 1, further comprising:
identifying a second application execution code of a second application and a second set of application execution dependencies of the second application;
determining that the resource files of the host system include resource files that correspond to the second set of application execution dependencies of the second application;
creating a second BRE for the second application on the host system;
creating a second set of directories in the second BRE for the second set of application execution dependencies of the second application;
copying the second application execution code to a second application directory in the second BRE;
mapping a second root file system of the host system into the second BRE;
mapping the resource files of the host system to the second set of directories in the BRE for the second set of application execution dependencies of the second application corresponding to the resource files; and
initiating execution of the application through the second BRE using the resource files of the host system that are mapped to the second set of application execution dependencies of the second application in the second BRE.

9. The method of claim 8, wherein the application is of a first programming language type and the second application is of a second programming language type.

10. The method of claim 8, wherein the root file system is of a first file system type and the second root file system is of a second file system type.

11. The method of claim 8, wherein at least one of the resource files of the host system is mapped to both the set of application execution dependencies of the application and the second set of application execution dependencies of the second application.

12. A host system comprising:
a memory storage unit comprising instructions; and
one or more processors in communication with the memory storage unit, wherein the one or more processors execute the instructions to:
identify application execution code of an application and a set of application execution dependencies of the application;
identify resource files of the host system;
determine that the resource files of the host system include resource files that correspond to the set of application execution dependencies of the application;
create a basic run-time environment (BRE) for the application on the host system;
map a root file system of the host system into the BRE;
create directories in the BRE for the set of application execution dependencies;
copy the application execution code of the application to an application directory in the BRE;
map the resource files of the host system to the directories in the BRE for the set of application execution dependencies corresponding to the resource files; and
initiate execution of the application through the BRE using the resource files of the host system that are mapped to the set of application execution dependencies of the application in the BRE.

13. The host system of claim 12, wherein the application execution code of the application and the set of application execution dependencies of the application are packaged in a container.

14. The host system of claim 12, wherein the resource files of the host system includes a plurality of different types of file systems.

15. The host system of claim 12, wherein the one or more processors further execute the instructions to:
identify a second application execution code of a second application and a second set of application execution dependencies of the second application;
determine that the resource files of the host system include resource files that correspond to the second set of application execution dependencies of the second application;
create a second BRE for the second application on the host system;
create a second set of directories in the second BRE for the second set of application execution dependencies of the second application;
copy the second application execution code of the second application to a second application directory in the second BRE;
map a second root file system of the host system into the second BRE;
map the resource files of the host system to the second set of directories in the BRE for the second set of application execution dependencies of the second application corresponding to the resource files; and
initiate execution of the application through the second BRE using the resource files of the host system that are mapped to the second set of application execution dependencies of the second application in the second BRE.

16. The host system of claim 15, wherein the application is of a first programming language type and the second application is of a second programming language type.

17. The host system of claim 15, wherein the root file system is of a first file system type and the second root file system is of a second file system type.

18. The host system of claim 15, wherein at least one of the resource files of the host system is mapped to both the set of application execution dependencies of the application and the second set of application execution dependencies of the second application.

19. A computer program product embodied in a non-transitory computer readable medium having computer executable program code embodied thereon, said computer executable program code when executed by a processor performs a resource sharing operation comprising: identifying application execution code of an application and a set of application execution dependencies of the application;
identifying resource files of the host system;
determining that the resource files of the host system includes resource files that correspond to the set of application execution dependencies of the application;
creating a basic run-time environment (BRE) for the application on the host system;
mapping a root file system of the host system into the BRE;
creating directories in the BRE for the set of application execution dependencies;
copying the application execution code of the application to an application directory in the BRE;
mapping the resource files of the host system to the directories in the BRE for the set of application execution dependencies corresponding to the resource files; and
initiating execution of the application through the BRE using the resource files of the host system that are mapped to the set of application execution dependencies of the application in the BRE.

20. The computer program product of claim 19, wherein the application execution code of the application and the set of application execution dependencies of the application are packaged in a container.
